(19) United States
(12) Patent Application Publication
(10) Pub. No.: US 2018/0318871 A1
(43) Pub. Date: Nov. 8, 2018

(54) FLOCKING POWDER COATING METHOD

(71) Applicant: CHUO HATSUJO KABUSHIKI KAISHA, Aichi (JP)

(72) Inventors: Takashi Yamashita, Aichi (JP); Hidekazu Ito, Aichi (JP); Seiki Ito, Aichi (JP); Toshio Kuwayama, Aichi (JP)

(21) Appl. No.: 15/774,813

(22) PCT Filed: Nov. 4, 2016
(86) PCT No.: PCT/JP2016/082813

§ 371 Date: May 9, 2018

(30) Foreign Application Priority Data
Nov. 9, 2015 (JP) 2015-219910

(51) Int. Cl. B05D 1/06; B05D 1/36; B05D 3/02

(52) U.S. Cl. CPC B05D 1/06; B05D 3/02; B05D 1/36

(57) ABSTRACT

This flocking powder coating method comprises: a powder coating attachment step for attaching a powder coating to a base material; a flocking step for attaching, by electrostatic force, a flocking organic filler to the attached powder coating layer; and a fixing step for forming a coating film by curing or hardening a resin included in the powder coating and thereby fixing a portion of the flocking organic filler to the coating film. According to this flocking powder coating method, coating and flocking can be performed without the use of an adhesive.

### TECHNICAL FIELD

The present disclosure relates to a flocking powder coating method capable of performing coating and flocking without using an adhesive.

### BACKGROUND ART

A spring assembly housing a coil spring is used for, for example, an automobile power lift-gate, etc. The coil spring needs to have anti-rust property and sound attenuation property. Therefore, the surface of the coil spring is subjected to coating for endowing the coil spring with the anti-rust property and flocking processing for endowing the coil spring with the sound attenuation property.

Flocking processing refers to such a processing mode, i.e., pre-coating the surface of a to-be-processed object with an adhesive, and then planting short fibers on the surface thereof. An electrostatic flocking method is widely known as a processing method of flocking. In the electrostatic flocking method, by making the short fibers, flying due to electrostatic force, stuck into and adhered to the adhesive-coated surface of the to-be-processed object, the short fibers are fixed on the surface of the to-be-processed object in a substantially erecting state (e.g., referring to patent documents 1 and 2).

### PRIOR ART DOCUMENTS

### Patent Documents

Patent document 1: Japanese Patent Publication No. 2002-224612

Patent document 2: Japanese Patent Publication No. H05-138813

Patent document 3: Japanese Patent Publication No. H10-258472

Patent document 4: Japanese Patent Publication No. 2004-16966

### SUMMARY

### Problem to be Solved by the Disclosure

According to the prior electrostatic flocking method, it is necessary to use an adhesive in order to adhere the short fibers. However, the adhesive does not have the anti-rust property. Thus, in order to possess the anti-rust property, a coating film having the anti-rust property must be formed prior to the flocking process. At this stage, such three procedures as coating, adhesive-coating and flocking are needed. In the procedure of coating, prior to the subsequent procedure of adhesive-coating, time is required for drying the coating film. Hence, the prior methods have the problems that the number of procedures is large, the processing is time-costing, and the manufacturing cost is high. In addition, the adhesive will be adhered to the falling short fibers during flocking. Since the adhesive is in a liquid form, it is difficult to recycle the falling short fibers. Further, many adhesives contain organic solvents, which places a heavy burden on the environment.

The present disclosure is proposed in view of such actual situations, and aims to provide a flocking powder coating method capable of performing coating and flocking without using an adhesive.

### Solution for Solving the Problems

The flocking powder coating method of the present disclosure is characterized by comprising a step of adhering a powder coating material, in which the powder coating material is adhered to a base (base material); a flocking step in which a flocking organic filler is adhered to the adhered powder coating material layer by electrostatic force; and a fixing step in which a portion of the flocking organic filler is fixed into a coating film, the coating film formed by curing or solidifying a resin contained in the powder coating material.

The powder coating material used in the flocking powder coating method of the present disclosure contains a thermosetting or thermoplastic resin. In the flocking step, the flocking organic filler is adhered to the powder coating material layer in a state where the resin contained in the adhered powder coating material layer is uncured (containing a thermosetting resin) or unsolidified (containing a thermoplastic resin). Then, in the fixing step, a coating film is formed by curing or solidifying the resin contained in the powder coating material. At this time, a portion of the flocking organic filler is fixed in the coating film, and the other portion of the flocking organic filler projects from the coating film. In this way, according to the flocking powder coating method of the present disclosure, the powder coating material is made to exert the function of an adhesive, and accordingly, the flocking can be performed even without the use of an adhesive. In other words, according to the flocking powder coating method of the present disclosure, the coating film drying procedure and the adhesive-coating procedure required in the prior coating procedure can be omitted. Therefore, compared with the prior art, it is possible to reduce number of the procedures so as to shorten the processing time, which thereby reduces the manufacturing cost.

According to the flocking powder coating method of the present disclosure, adhesives for fixing the flocking organic fillers are not needed. In addition, the powder coating material does not contain an organic solvent. Thus, according to the flocking powder coating method of the present disclosure, no organic solvents are used. Therefore, according to the flocking powder coating method of the present disclosure, it is possible to reduce the burden on the environment. Compared with a liquid coating material, the powder coating material seldom flies apart, and is easy to recycle. In the case of a liquid coating material, since the amount of the liquid coating material that can be coated onto the surface of the base is determined by the surface tension, if an excessive amount is used, the excessive liquid coating material will flow away, making it difficult to realize increase of the film thickness. In this regard, if a powder coating material is used, it is easy to adjust the thickness of the coating film, which also makes it very easy to increase the thickness of the film. Additionally, by proper selection for the type of the resin cooperating with the powder coating material, additives, etc., it is possible to impart desired properties to the coating film. For example, by selecting the resins with high anti-rust property, it is possible to improve the anti-rust property of the coating film.

In the flocking powder coating method of the present disclosure, the flocking organic filler is adhered to a powder coating material layer which is not in a liquid state and is dry, thus it is easy to recycle and reuse the unattached flocking organic filler. The flocking organic filler is more flexible than inorganic fillers, and therefore is excellent in touch feeling and not easy to break off upon adhesion and can maintain the flocking state easily.

In addition, patent document 3 discloses a method in which a surface of a surface-treated steel plate is roll-coated or spray-coated with a flocking adhesive aqueous coating composition composed of waterborne epoxy-modified polyurethane resin, etc. to form a flocked planting layer, which is then electrostatically flocked with organic short fibers. In addition, patent document 4 discloses a flocking method, comprising spraying a single-component coating comprising a carbamate emulsion onto a base, and then spraying piles. The flocking adhesive aqueous coating composition and the single-component coating comprising a carbamate emulsion used in patent documents 3 and 4 are both liquid coating materials, rather than powder coating materials.

### BRIEF DESCRIPTION OF DRAWINGS

FIG. 1 is an SEM photograph (at a magnification of 20 times) of a section of a coil spring of Example 1.

FIG. 2 is an SEM photograph (at a magnification of 100 times) of a section of the vicinity of the surface of the same coil spring.

FIG. 3 is an SEM photograph (at a magnification of 100 times) of a section of the vicinity of the surface of a coil spring of Reference Example.

FIG. 4 is a model diagram showing a state prior to baking in a flocking powder coating method of Example.

FIG. 5 is a model diagram showing a state prior to baking in a flocking powder coating method of Reference Example.

FIG. 6 is an overview of a compression testing device.

FIG. 7 is a chart illustrating the vibration levels of knocking sounds in a compression test.

### REFERENCE SIGNS

10: coil spring; 11: powder coating material; 12: flocking organic filler; 20: compression testing device; 21: outer cylinder; 22: coil spring; 23: clamp; 24: acceleration pickup; 25: charge amplifier; 26: FFT analyzer; 210: core rod; 211: spring seat.

### DETAILED DESCRIPTION OF EMBODIMENTS

Embodiments of the flocking powder coating method of the present disclosure are described below. In addition, the flocking powder coating method of the present disclosure is not limited to the following embodiments, and can be implemented, without departing from the spirit of the present disclosure, in various embodiments that are subjected to modifications, improvements and the like that a person skilled in the art can make.

The flocking powder coating method of the present disclosure comprises a step of adhering a powder coating material, a flocking step, and a fixing step. The steps will be described sequentially below.

(1) Step of Adhering a Powder Coating Material

This step is a step of adhering a powder coating material to a base. The powder coating material comprises basic materials forming the coating film, i.e., resin, a curing agent, a pigment, etc. Resin may be selected from thermosetting resins and thermoplastic resins. Examples of the thermosetting resins may include epoxy resin, polyester resin, acrylic resin, fluororesin, phenolic resin, melamine resin, polyurethane resin, silicon resin, etc. Examples of the thermoplastic resins may include polyethylene resin, polypropylene resin, polyvinyl chloride resin, acrylonitrile-butadiene-styrene (ABS) resin, methacrylic resin, nylon resin, etc. For example, when needing to improve the anti-rust property of the coating film, epoxy resin is preferably selected. In addition, besides the anti-rust property, in the case of outdoor use of the flocking powder coated article of the present disclosure, when needing to impart weatherability to the coating film, it is preferable that epoxy resin and carboxyl-containing polyester resin are used in combination.

Examples of epoxy resin may include, for example, bisphenol A epoxy resin, bisphenol F epoxy resin, crystalline epoxy resin, etc. In addition, examples of polyester resins may include the resins resulting from ester exchange or polycondensation reaction between polyols such as ethylene glycol, diethylene glycol, triethylene glycol, propylene glycol, butylene glycol, pentylene glycol, hexylene glycol etc., and carboxylic acids such as terephthalic acid, maleic acid, isophthalic acid, succinic acid, adipic acid, sebacic acid, etc.

Examples of the curing agent may include, for example, aromatic amines, acid anhydrides, blocked isocyanate, hydroxyalkylamide (HAA), triglycidyl isocyanurate (TGIC), aliphatic dibasic acids, dicyandiamide derivatives, organic acid dihydrazide derivatives, etc. For the resin, when epoxy resin and carboxyl-containing polyester resin are used in combination, carboxyl-containing polyester resin functions as a curing agent for epoxy resin.

Examples of the pigment, for example, a coloring pigment, may include inorganic pigments such as carbon black, titanium dioxide, rouge, loess, etc., and organic pigments such as quinacridone red, phthalocyanine blue, benzidine yellow, etc. In addition, examples of extender pigments may include calcium carbonate, magnesium carbonate, talc, silica, barium sulfate, etc. The mechanical properties such as flexibility and impact resistance of the coating film can be adjusted according to the particle diameter and particle shape of the extender pigments.

In addition to the aforementioned components, the powder coating material may also comprise various additives as desired. Examples of the additives may include surface conditioners, ultraviolet absorbers, antioxidants, antistatic agents, flame retardants, etc. The powder coating material can also be manufactured by known methods, for example, manufactured by melting and mixing materials such as resins and the like, and then grinding.

There are no particular limits on the base. For example, as to members made of metals, spring members such as coil springs, matching members for housing spring members, etc. can be on the list. For the materials of the spring members, spring steel, etc. used for springs are generally preferred. As to the spring members, for example, preferably, the spring steel or the like is subjected to hot forming or cold forming and then to shot blasting, etc., so as to adjust the surface roughness. In addition, it is preferable to form a membrane of phosphates such as zinc phosphate and iron phosphate on the surface of the base of the spring member. By forming a coating film on the phosphate membrane, the corrosion resistance and the adhesion of the coating film are improved. The corrosion resistance can be further improved especially when the phosphate is zinc phosphate. The phosphate membrane can be formed just by known methods. For example, there are soaking methods in which a spring member is soaked in a phosphate solution tank, spraying methods in which a phosphate solution is sprayed onto a spring member with a spray gun or the like, etc.

As to the method for adhering a powder coating material to a base, known methods can be used. For example, examples thereof may include a flowing soaking method, an electrostatic flowing soaking method, an electrostatic spraying method, etc. In particular, the electrostatic spraying method and the electrostatic flowing soaking method that use electrostatic force are preferable. In the case where the electrostatic spraying method is used, it is sufficient that the powder coating material is charged via the nozzle of the electrostatic spray gun so as to be adhered to the surface of the base. The nozzle of the electrostatic spray gun is not necessarily applied with a voltage, as long as the powder coating material is enabled to be charged. In the case where the electrostatic flowing soaking method is used, it is sufficient to make the powder coating material flow in the flowing soaking tank and simultaneously charged by a needle discharge electrode that has been applied with a voltage, so as to make the power coating adhered to the surface of the base.

In this step, the operation of adhering the powder coating material to the base may be performed for more than one time or two times. For example, adhering of the powder coating material may also be repeated again after the powder coating material is adhered to the base.

(2) Flocking Step

This step is a step of adhering flocking organic fillers to the adhered powder coating material layer by electrostatic force. The powder coating material layer in this step refers to a state where the resin contained in the powder coating material has not been cured or solidified. In other words, when the powder coating material contains a thermosetting resin, the flocking organic fillers are adhered in a state where the resin is uncured. Alternatively, when the powder coating material contains a thermoplastic resin, the flocking organic fillers are adhered in a state where the resin is unsolidified.

To adhere the flocking organic fillers by electrostatic force, it is sufficient to use an electrostatic spray gun, an electrostatic flowing soaking tank, etc. In the case where an electrostatic spray gun is used, it is sufficient that the flocking organic filler is charged via the nozzle of the electrostatic spray gun so as to be sprayed onto the powder coating material layer. The nozzle of the electrostatic spray gun is not necessarily applied with a voltage, as long as the flocking organic filler is enabled to be charged. In the case where an electrostatic flowing soaking tank is used, it is sufficient to make the flocking organic filler flow in the electrostatic flowing soaking tank and simultaneously charged by a needle discharge electrode that has been applied with a voltage, so as to make the flocking organic filler adhered to the powder coating material layer.

There are no particular limits on the type of the flocking organic filler (referred to as “filler” sometimes hereinafter). For example, examples thereof may include nylon fibers, polyester fibers, synthetic fibers, cotton fibers, polyethylene fibers, aramid fibers, fluorofibers, etc. In particular, it is preferable to comprise fibers selected from one or more of nylon fibers, polyester fibers, rayon fibers, cotton fibers and polyethylene fibers.

As the flocking organic filler, a filler having a surface resistance value greater than or equal to 1×10⁵Ω and smaller than 1×10¹⁸Ω can be used. In this description, the value measured by a teraohmmeter “SM-8220” manufactured by HIOKI (Corporation) is used as the surface resistance value. When the surface resistance value of the flocking organic fillers is smaller than 1×10⁵Ω, the flocking organic fillers have a high electrical conductivity and can be discharged easily, and accordingly, the flying property of the fillers becomes poor, which makes it difficult to perform flocking by electrostatic force. More preferably, the surface resistance value is 1×10⁸Ω or greater. On the contrary, if the surface resistance value is 1×10¹⁸Ω or greater, the flying property of the fillers becomes poor due to that the fillers are excessively charged, which makes it difficult to perform flocking by electrostatic force. More preferably, the surface resistance value is smaller than 1×10¹⁷Ω, and further smaller than 1×10¹¹Ω.

As to the flocking organic filler, in order to improve dispersibility or inhibit a state of being excessively charged, it is feasible to use the fibers that have been subjected to various surface treatments such as electrodeposition treatment, water absorption treatment, waterproofing treatment, anti-rust treatment (primer), etc. For example, it is preferable that the flocking organic fillers have, on the surface thereof, an electrodeposition-treated film. By comprising the electrodeposition-treated film, the surface resistance value of the fillers is adjusted to a desired value, which thereby inhibits the fillers from being excessively charged and improves the flying ability at the time of flocking. In addition, fibers are easy to aggregate, and therefore tend to be tangled into a mass. In this regard, if there is an electrodeposition-treated film on the surface, the dispersibility of the fibers (the flocking organic fillers) will be improved, which thereby can inhibit aggregation of the fillers so as to achieve a substantially uniform flocking state.

The electrodeposition-treated film is formed by performing an electrodeposition treatment on the surfaces of the fibers used as the flocking organic fillers. The electrodeposition treatment may be performed by treating the fibers using tannin, tartar emetic, etc. so as to form a tannin compound, etc. on the surfaces of the fibers. In addition, the electrodeposition treatment may be performed by preparing a solution by properly mixing an inorganic salt such as barium chloride, magnesium sulfate, sodium silicate, sodium sulfate or the like, a surfactant such as quaternary ammonium salt, higher alcohol sulphate, betaine surfactants or the like, and an organic silicon compound (colloidal silica), and treating the fibers with the solution, so as to make a silicon compound adhered to the surfaces of the fibers.

The flocking organic fillers are fibrous. The length of the filler in the length direction is not particularly limited, but if the filler is too short, it will be buried in the powder coating material, making it impossible to achieve the desired flocking state. For example, the length of the filler is preferably 50 μm or greater, more preferably 200 μm or greater, and further preferably 500 μm or greater. On the other hand, if the filler is too long, it will topple, making it impossible to achieve the desired flocking state. For example, the length of the filler is preferably 2,000 μm or smaller, more preferably 1,000 μm or smaller, and further preferably 600 μm or smaller. The maximum length (thickness) of the filler in the width direction is not particularly limited, but if the filler is too thin, it will curl due to self-weight, making it impossible to achieve the desired flocking state. For example, the thickness of the filler is preferably 5 μm or greater, more preferably 10 μm or greater, and further preferably 20 μm or greater. On the other hand, if the filler is too thick, the sense of touch will become bad. For example, the thickness of the filler is preferably 50 μm or smaller, more preferably 40 μm or smaller, and further preferably 30 μm or smaller.

The amount of the adhered flocking organic fillers is preferably, for example, greater than or equal to 1.2 mg/cm² and smaller than or equal to 80 mg/cm². When the amount of the adhered flocking organic fillers is smaller than 1.2 mg/cm², the manufacture thereof is difficult, and due to less fillers, the effects e.g., the sound attenuation effect, etc. achieved by flocking is weakened. The amount of the adhered flocking organic fillers is preferably 2 mg/cm² or greater. On the other hand, if the amount exceeds 80 mg/cm², it becomes difficult to adhere the fillers and the loss becomes large. Furthermore, the effects achieved are not different even if the amount of the adhered fillers exceeds 80 mg/cm². If the manufacturing cost is taken into account, it is preferable that the amount of the adhered flocking organic fillers is 18 mg/cm² or less. In order to ensure sound attenuation property and further reduce the manufacturing cost, the amount is preferably 10 mg/cm² or less. In addition, the amount of the adhered flocking organic fillers can be measured on a contact surface of a flocking powder-coated member in contact with a matching member.

(3) Fixing Step

This step is a step of forming a coating film by curing or solidifying a resin contained in the powder coating material, and thereby fixing a portion of the flocking organic filler in the coating film.

In this step, when the resin contained in the powder coating material is a thermosetting resin, the resin can be cured just by heating; and when the resin contained in the powder coating material is a thermoplastic resin, the resin can be solidified just by cooling after it is molten by heating. The heating temperature, heating duration, etc. can be determined appropriately just according to the type of the resin. In addition, heating can be performed just by using a commonly-used electric furnace, a hot air dryer, etc.

The coating film is formed by curing or solidifying the resin. At this time, portions of the flocking organic fillers are buried and fixed in the coating film, and the other portions of the flocking organic fillers project from the coating film. The thickness of the coating film or the thickness of a layer constituted by the projecting flocking organic fillers can be appropriately determined depending upon the desired properties. For example, when the length of the flocking organic filler in the length direction is greater than or equal to 50 μm and smaller than or equal to 2,000 μm, the thickness of the coating film is preferably greater than or equal to 30 μm and smaller than or equal to 500 μm. When the thickness of the coating film is smaller than 30 μm, the effects brought forth by coating, such as imparting the anti-rust property, etc., become poor. Moreover, as it is difficult to stick the flocking organic fillers and the lengths of the buried flocking organic fillers are small, it is impossible to adequately fix the flocking organic fillers. For example, portions of the flocking organic fillers buried in the coating film preferably have a length of 20 μm or greater. On the contrary, if the thickness of the coating film exceeds 500 μm, it becomes difficult to adhere the flocking organic fillers.

### EXAMPLES

Next, the present disclosure is described more specifically with examples.

(Flocking Powder Coating)

The flocking powder coating is performed by using a coil spring made of spring steel as the base. The total number of turns of the coil spring is 50, and the dimensions of the coil spring are as follows: an outer diameter of 27.5 mm, a free height of 570 mm, and a wire diameter of 3.7 mm. The epoxy/polyester powder coating material “INNOVAX (registered trademark) H-series” manufactured by SHINTO PAINT (Corporation) is used as the powder coating material. The nylon fibers (3.3 dtex (equivalent to 19.3 μm if converted into thickness), 500 μm in length, with an electrodeposition-treated film, having a surface resistance value of 10¹⁰˜10¹³Ω) manufactured by NISSEN Flock Manufacturing (Corporation) are used as the flocking organic fillers.

First, the powder coating material is sprayed onto the coil spring by an electrostatic spray gun (the step of adhering powder coating material). “BPS700” (having a reflective plate-type nozzle) manufactured by ASAHI SUNAC (Corporation) is used as the electrostatic spray gun. The spraying conditions are as follows: the voltage is 100 kV, the spraying rate is 70 g/min, the moving speed of the electrostatic spray gun is 40 mm/sec, and the working distance is 200 mm. The spraying is performed in a manner as follows: moving, in the state where the coil spring is vertically placed (axial direction=up-down direction), the electrostatic spray gun from the bottom up, from the top down and from the bottom up, i.e. moving the electrostatic spray gun in the up-down direction for 3 times (1.5 roundtrips), and then rotating the coil spring about the axis by 180°, and moving the electrostatic spray gun for 1.5 roundtrips in the same manner.

Next, the flocking organic fillers are sprayed onto the coil spring by an electrostatic spray gun (the flocking step). “NU-070P” manufactured by ASAHI SUNAC (Corporation) is used as the electrostatic spray gun. A nozzle thereof is in a flat shape, which has a slit of 4 mm in width. The spraying conditions are as follows: the voltage is 100 kV, the spraying rate is 100 g/min, the carrier gas pressure is 0.1 MPa, the moving speed of the electrostatic spray gun is 50 mm/sec, and the working distance is 200 mm. The spraying is performed in a manner as follows: like those performed when spraying the powder coating material, moving the electrostatic spray gun from the bottom up in the state where the coil spring is vertically placed, wherein at this time, the slit of the nozzle faces the same direction as the axial direction of the coil spring; thereafter, rotating the coil spring about the axis by 90° each time; and moving the electrostatic spray gun in the same manner each time. In this way, the operation of spraying the flocking organic fillers to the whole periphery of the coil spring is performed for four times in total.

The coil spring is then placed in a hot air drier for baking at 200° C. for 20 minutes (the fixing step). In this way, epoxy resin and polyester resin in the powder coating material are cured to form a coating film. The coil spring subjected to the flocking powder-coating in this way is referred to as the coil spring of Example 1.

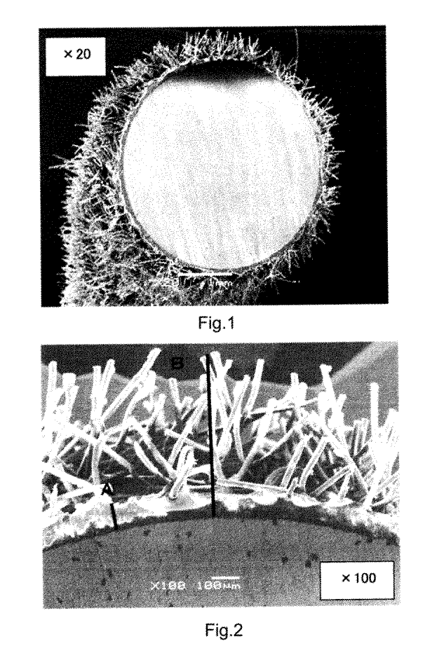

FIG. 1 shows a scanning electron microscope photograph (SEM photograph) (at a magnification of 20 times) of a section of a coil spring of Example 1. FIG. 2 shows an SEM photograph (at a magnification of 100 times) of a section of the vicinity of the surface of the same coil spring. As shown in FIG. 1 and FIG. 2, portions of the flocking organic fillers are buried in the coating film, and the other portions thereof project from the coating film. In FIG. 2, as denoted by A, the thickness of the coating film is 100 μm. In FIG. 2, as denoted by B, the total thickness of the coating film and the flocking organic fillers (the thickness of the flocking coating layer) is 600 μm. The amount of the adhered flocking organic fillers is 3 mg/cm².

As a reference example, a coil spring is subjected to flocking powder coating by using a powder coating composition prepared in advance by dry-mixing a powder coating material with flocking organic fillers. The coil spring, and the powder coating material and the flocking organic fillers contained in the powder coating composition are the same as those used in the preceding flocking powder coating. The mixing ratio, i.e. mass ratio, of the powder coating material to the flocking organic fillers is 1:1. The flocking powder coating method of the reference example is described below.

First, the powder coating composition is sprayed onto the coil spring by an electrostatic spray gun. “VERSA-SPRAY II” manufactured by Nordson (Corporation) is used as the electrostatic spray gun. A nozzle thereof is in a flat shape, which has a slit of 4 mm in width. The spraying conditions are as follows: the voltage is 100 kV, the spraying rate is 60 g/min, the carrier gas pressure is 2.5 MPa, the moving speed of the electrostatic spray gun is set to be 50 mm/sec, and the working distance is set to be 200 mm. The spraying is performed in a manner as follows: moving the electrostatic spray gun from the top down in a state where the coil spring is placed vertically, wherein at this time, the slit of the nozzle faces the same direction as the axial direction of the coil spring, thereafter, rotating the coil spring about the axis by 90° to move the electrostatic spray gun from the bottom up, then rotating the coil spring about the axis by 180° in the same direction to move the electrostatic spray gun from the top down, and finally, rotating the coil spring about the axis by 90° in a returning direction to move the electrostatic spray gun from the bottom up. Thus, the operation of spraying the powder coating composition to the whole periphery of the coil spring is performed for four times in total. The coil spring is then placed in a hot air drier for baking at 200° C. for 20 minutes. In this way, epoxy resin and polyester resin in the powder coating material are cured to form a coating film. The coil spring subjected to the flocking powder-coating in this way is referred to as the coil spring of Reference Example 1.

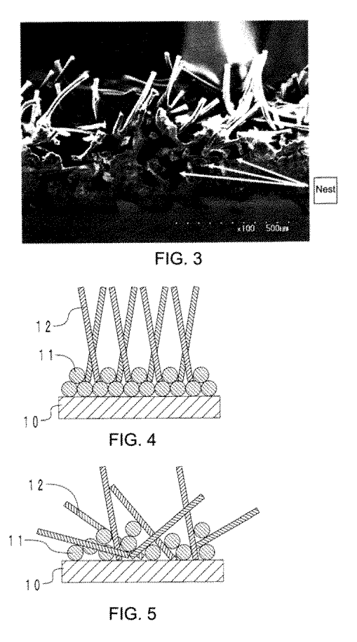

FIG. 3 shows an SEM photograph (at a magnification of 100 times) of a section of the vicinity of the surface of the coil spring of Reference Example 1. As shown in FIG. 3, empty holes called “nests” are present in the coating film of the coil spring of Reference Example 1. In contrast, as shown in the preceding FIG. 2, empty holes are hardly seen in the coating film of the coil spring of Example 1. The reason for this is described below.

FIG. 4 shows a model diagram showing a state prior to baking in the flocking powder coating method of Example. FIG. 5 shows a model diagram showing a state prior to baking in the flocking powder coating method of Reference Example. As shown in FIG. 4 and FIG. 5, a powder coating material 11 and flocking organic fillers 12 are adhered to a surface of a coil spring 10. Portions of the flocking organic fillers 12 are buried in the powder coating material 11, and the other portions thereof project from the powder coating material 11.

According to the flocking powder coating method of the example, the flocking organic fillers are sprayed after a powder coating material layer is formed by spraying the powder coating material in advance. In this case, as shown in FIG. 4, the flocking organic fillers 12 are substantially vertically stuck into the powder coating material 11. Therefore, when the powder coating material 11 is molten to spread over the surface of the coil spring 10 during baking, air is hardly entrained therein. In contrast, if a powder coating composition prepared by dry-mixing the powder coating material with the flocking organic fillers is sprayed, the powder coating material 11 and the flocking organic fillers 12 are adhered in an intertwined manner as shown in FIG. 5. Therefore, when the powder coating material 11 is molten to spread over the surface of the coil spring 10 during baking, air is easily entrained therein. Thus, it can be considered that empty holes are prone to be formed in the coating film.

(Evaluation of Corrosion Resistance)

A salt spray test is conducted on the coil springs of Example 1 and Reference Example 1 to evaluate the corrosion resistance (anti-rust property). In the salt spray test, the salt spraying tester “STP-160” manufactured by Suga Test Instruments (Corporation) is used. The test conditions are based on the neutral salt spray test in the salt spray test methods specified in JIS (Japanese Industrial Standards) Z 2371:2000, wherein the salt concentration is 5 mass %, the temperature is 35° C., and whether there is red rust generated is determined after 72 hours, 240 hours, 480 hours and 720 hours, respectively. As to determining whether there is red rust, the flocking coating layer, etc. is stripped to confirm the texture of the coil spring through visual observation.

For comparison, a coil spring flocked by a prior method in which an adhesive is used is also subjected to the salt spray test to evaluate the corrosion resistance. For the coil spring which is used as the base, a coil spring pre-coated with Geomet (registered trademark) is used. By coating the Geomet, a layered Geomet membrane formed by superposition of inorganic adhesive-adhered metal flakes is formed on the surface of the coil spring. The Geomet membrane has anti-rust property. Total number of turns, dimension, etc. of the coil spring are the same as those used in the flocking powder-coating in Example 1. The acrylic acid-styrene copolymer resin adhesive “Yodosol (registered trademark) AA76” manufactured by Henkel Japan (Corporation) is used as the adhesive. The flocking organic filler is the same as that used in the flocking powder-coating in Example 1. The flocking method is as follows.

First, an adhesive is sprayed onto the coil spring by a spray gun (“W-100” manufactured by ANEST IWATA (Corporation), having a nozzle with the diameter of 1.8 mm). Spraying is performed by moving the spray gun back and forth a dozen times while rotating the coil spring. The spray gun is moved at a speed of 600 mm/sec, the spraying duration is 80 seconds, and the working distance is 50 mm. Next, the flocking organic fillers are sprayed by an electrostatic spray gun onto the surface of the sprayed adhesive. The electrostatic spray gun used is the same as that used in the flocking powder-coating in Reference Example 1 (“VERSA-SPRAY II” manufactured by Nordson (Corporation)). The spraying conditions are as follows: the voltage is 1 kV, the spraying rate is 100 g/min, the moving speed of the electrostatic spray gun is 600 mm/sec, the spraying duration is 60 seconds, and the working distance is 50 mm. Spraying is performed by moving the electrostatic spray gun back and forth a dozen times while rotating the coil spring. The coil spring is then placed in a hot air dryer for baking at 70° C. for 20 minutes, and then at 130° C. for 5 minutes. The coil spring processed by flocking in this manner is referred to as the coil spring of Comparative Example 1. As to determining whether there is red rust on the coil spring of Comparative Example 1, the flocking layer (the fillers and the adhesive layer), etc. is stripped to confirm the texture of the coil spring through visual observation.

The results of the salt spray test are as follows: no red rust is observed on the coil springs of Example 1, Reference Example 1 and Comparative Example 1 even after 720 hours have lapsed. Thus, it is determined that the coil spring of Example 1 has an equivalent corrosion resistance, compared with a coil spring obtained by a prior flocking method.

(Evaluation of Sound Attenuation Property)

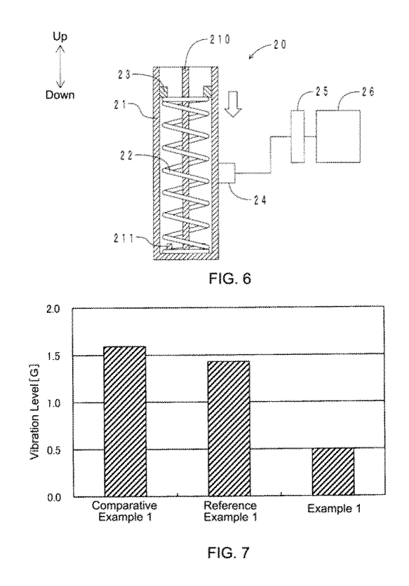

If a coil spring is compressed to bend, the bent portion will abut against an adjacent member, thereby producing a knocking sound. Thus, a compression test is conducted on the coil springs of Example 1, Reference Example 1 and Comparative Example 1, to evaluate the sound attenuation property brought about by the flocking by measuring the vibration levels of the knocking sounds produced by the bending of the coil springs. FIG. 6 shows an overview of a compression testing device.

As shown in FIG. 6, the compression testing device 20 comprises an outer cylinder 21, a coil spring 22 and a clamp 23. The outer cylinder 21 is in a shape of a cylinder that opens upwardly and has a bottom. A core rod 210 is erected on the bottom surface of the outer cylinder 21. The core rod 210 is provided at the radial center of the outer cylinder 21. A spring seat 211 is provided at the bottom surface of the outer cylinder 21 in a manner of surrounding the core rod 210. The coil spring 22 is housed in the outer cylinder 21. The coil spring 22 is provided in such a way that the core rod 210 is taken as an axis, with the lower end turn sleeved over the spring seat 211. The clamp 23 is in a ring shape and can move in an up-down direction along the inner circumferential surface of the outer cylinder 21. The clamp 23 abuts against the upper end turn of the coil spring 22. An acceleration pickup 24 is mounted on the outer circumferential surface of the outer cylinder 21. The acceleration pickup 24 is connected with an FFT (fast Fourier transform) analyzer 26 via a charge amplifier 25.

The clamp 23 is made to move downwardly to compress the coil spring 22. If the compression load reaches a certain value, the axis of the coil spring 22 is bent into a wave form or helical-form or the like. That is, the coil spring 22 is bent. Thus, a bent portion is formed on the coil spring 22. When the bent portion abuts against the inner circumferential surface of the outer cylinder 21, a knocking sound is generated. The generated knocking sound is detected by the acceleration pickup 24, and the vibration level is measured by the FFT analyzer 26. In this example, “2354A” manufactured by SHOWA SOKKI (Corporation) is used as the acceleration pickup 24. In addition, “CH-1200A” manufactured by ONO SOKKI (Corporation) is used as the charge amplifier 25, and “DS-3000” manufactured by ONO SOKKI is used as the FFT analyzer 26.

FIG. 7 shows the vibration levels of the knocking sounds in the coil springs of Example 1, Reference Example 1 and Comparative Example 1. As shown in FIG. 7, the vibration level of the coil spring of Reference Example 1 is slightly lower than that of the coil spring of Comparative Example 1. On the other hand, the vibration level of the coil spring of Example 1 is reduced to about ⅓ of the vibration level of the coil spring of Comparative Example 1. Thus, it is confirmed that the flocking coating layer formed by the flocking powder coating method of the present disclosure has excellent sound attenuation property.

1. A flocking powder coating method comprising:
a step of adhering a powder coating material, in which the powder coating material is adhered to a base;
a flocking step, in which a flocking organic filler is adhered to an adhered powder coating material layer by electrostatic force; and
a fixing step, in which a portion of the flocking organic filler is fixed into a coating film, the coating film formed by curing or solidifying a resin contained in the powder coating material.

2. The flocking powder coating method according to claim 1, wherein in the flocking step, the flocking organic filler is sprayed onto the powder coating material layer by an electrostatic spray gun.

3. The flocking powder coating method according to claim 1, wherein a length of the flocking organic filler in a length direction of the flocking organic filler is greater than or equal to 50 μm and less than or equal to 2,000 μm, and
in the fixing step, a thickness of the coating film is greater than or equal to 30 μm and less than or equal to 500 μm.

4. The flocking powder coating method according to claim 1, wherein the flocking organic filler has a surface resistance value greater than or equal to 1×10⁵Ω and smaller than 1×10¹⁸Ω.

5. The flocking powder coating method according to claim 4, wherein a surface of the flocking organic filler is provided with an electrodeposition-treated film.

6. The flocking powder coating method according to claim 1, wherein the flocking organic filler comprises fibers selected from one or more of the group consisting of nylon fibers, polyester fibers, rayon fibers, cotton fibers and polyethylene fibers.

7. The flocking powder coating method according to claim 1, wherein the powder coating material comprises a thermosetting resin, and
in the fixing step, the thermosetting resin is cured by heating.

8. The flocking powder coating method according to claim 2, wherein a length of the flocking organic filler in a length direction of the flocking organic filler is greater than or equal to 50 μm and less than or equal to 2,000 μm, and
in the fixing step, a thickness of the coating film is greater than or equal to 30 μm and less than or equal to 500 μm.

9. The flocking powder coating method according to claim 2, wherein the flocking organic filler has a surface resistance value greater than or equal to 1×10⁵Ω and smaller than 1×10¹⁸Ω.

10. The flocking powder coating method according to claim 3, wherein the flocking organic filler has a surface resistance value greater than or equal to 1×10⁵Ω and smaller than 1×10¹⁸Ω.

11. The flocking powder coating method according to claim 2, wherein the flocking organic filler comprises fibers selected from one or more of the group consisting of nylon fibers, polyester fibers, rayon fibers, cotton fibers and polyethylene fibers.

12. The flocking powder coating method according to claim 3, wherein the flocking organic filler comprises fibers selected from one or more of the group consisting of nylon fibers, polyester fibers, rayon fibers, cotton fibers and polyethylene fibers.

13. The flocking powder coating method according to claim 5, wherein the flocking organic filler comprises fibers selected from one or more of the group consisting of nylon fibers, polyester fibers, rayon fibers, cotton fibers and polyethylene fibers.

14. The flocking powder coating method according to claim 8, wherein the flocking organic filler comprises fibers selected from one or more of the group consisting of nylon fibers, polyester fibers, rayon fibers, cotton fibers and polyethylene fibers.

15. The flocking powder coating method according to claim 2, wherein the powder coating material comprises a thermosetting resin, and
in the fixing step, the thermosetting resin is cured by heating.

16. The flocking powder coating method according to claim 3, wherein the powder coating material comprises a thermosetting resin, and
in the fixing step, the thermosetting resin is cured by heating.

17. The flocking powder coating method according to claim 4, wherein the powder coating material comprises a thermosetting resin, and
in the fixing step, the thermosetting resin is cured by heating.

18. The flocking powder coating method according to claim 5, wherein the powder coating material comprises a thermosetting resin, and
in the fixing step, the thermosetting resin is cured by heating.

19. The flocking powder coating method according to claim 8, wherein the powder coating material comprises a thermosetting resin, and
in the fixing step, the thermosetting resin is cured by heating.

20. The flocking powder coating method according to claim 9, wherein the powder coating material comprises a thermosetting resin, and
in the fixing step, the thermosetting resin is cured by heating.
